(19) United States
(12) Patent Application Publication
(10) Pub. No.: US 2026/0344624 A1
(43) Pub. Date: Nov. 5, 2026

(54) LEASH TRAINING SYSTEM AND METHODS OF USING THE SAME

(71) Applicant: Jessica Lombardo, Chattanooga, TN (US)

(72) Inventor: Jessica Lombardo, Chattanooga, TN (US)

(21) Appl. No.: 19/198,823

(22) Filed: May 5, 2025

(51) Int. Cl. A01K 27/00

(52) U.S. Cl. CPC A01K 27/004; A01K 27/005

(57) ABSTRACT

Various embodiments are direct to a leash training system and methods of leash training. In various embodiments, the leash training system comprises a retractable leash assembly comprising a housing, a spool, and a length of flexible material having a first end and a second end, wherein the length of flexible material is configured to wind around the spool and move between a spooled configuration and an unspooled configuration; a clicking mechanism configured to produce one or more noises when the length of flexible material moves in a first direction; a leash attachment connector coupled to the housing and configured to removably couple the leash training system to a leash; and a leash clip configured to removably couple the leash training system to a pet.

### FIELD OF THE INVENTION

Various embodiments described herein relate generally to leash training systems and methods. More particularly, various embodiments described herein relate to a leash training system configured to produce a noise to mark a behavior of a pet on a leash and methods of using the same.

### BACKGROUND

Leash training a pet, such as a dog, is difficult. For example, it is difficult to train a dog not to pull on a leash because it may not be clear to the dog that the pulling is the action that the trainer is seeking to stop. A specific behavior, such as sitting may be easier for a dog to understand because there is a clear point when the dog is sitting versus not sitting. As humans we know when our dog is sitting and can mark that behavior. The dog then connects the marked behavior with the reward. Pulling on a leash is more complex because there is not a clear point when the pulling happens. Is it when the leash does not have any slack, or when there is a little tension, or when there is a lot of tension? The definition of pulling for a trainer can be subjective and is likely to change depending on the trainer and on the dog. And a trainer is further likely to change their own definition of pulling just based on the situation. For example, at the beginning of the walk a trainer may be more relaxed but as leash pulling behavior continues, get frustrated and start correcting sooner. Or the opposite happens, a trainer may start out trying to correct the pulling behavior right when it starts each time but get tired and less consistent with trying to correct the pulling behavior as the walk continues.

This inconsistency and lack of clear indication of which behavior a trainer is trying to correct can be confusing to a dog. For example, the dog may have trouble connecting good leash behavior, such as not pulling, with a reward or connecting bad leash behavior, such as pulling, with negative feedback. This confusion can be exacerbated by the numerous distractions, such as smells, animals, other people, etc., that a dog will commonly face when going on a walk. Leash training can therefore be difficult because normal rewards or negative feedback used in dog training can be less effective in encouraging or discouraging specific leash behavior.

As such, what is needed is a system and method for consistent marking of specific leash behavior. For example, consistently marking a pulling behavior to increase association between that behavior and negative feedback, or consistently marking non-pulling behavior to increase association between that behavior and a reward can improve leash training outcomes.

### BRIEF SUMMARY

Various embodiments are direct to a leash training system and methods of leash training. In an example embodiment, a leach training system is provided. The leash training system can include a retractable leash assembly. The retractable leash assembly can include a housing. The retractable leash assembly can include a spool. The retractable leash assembly can include a length of flexible material. The length of flexible material can have a first end and a second end. The length of flexible material can be configured to wind around the spool and move between a spooled configuration and an unspooled configuration. The leash training system can include a clicking mechanism. The clicking mechanism can be configured to produce one or more noises when the length of flexible material moves in a first direction. The clicking mechanism can include a leash attachment connector coupled to the housing. The leash attachment connector can be configured to removably couple the leash training system to a leash. The leash training system can include a leash clip. The leash clip can be configured to removably couple the leash training system to a pet. The first end of the length of flexible material can be coupled to the leash clip and the second end of the length of flexible material can be coupled to the spool.

In some embodiments, the leash training system can be disposed between the leash and the pet. In some embodiment the leash training system can include a safety strap. The safety strap can have a first end and a second end, wherein the first end of the safety strap can be coupled to the leash clip and the second end of the safety strap can be coupled to the leash attachment connector. In some embodiments the spool can include a spring. The spring can be configured to bias the spool in the spooled configuration. In some embodiments, the clicking mechanism can be configured to produce one or more noises every time a first length of the length of flexible material moves in the first direction. In some embodiments, the clicking mechanism can be configured to produce one or more noises every time the spool rotates a first angle of rotation. In some embodiments, the clicking mechanism can produce one or more noises electronically. In some embodiments, the first direction can be an unspooling direction. In some embodiments, the first direction can be a spooling direction. In some embodiments, the leash clip can be configured to removably couple the leash training system to a pet by clipping to a collar or harness on the pet.

In another example embodiments, a leash training method for a pet is provided. The method can include coupling a leash training system to the pet and a leash. The leash training system can be disposed between the pet and the leash. The method can include extending a length of flexible material of the leash training system in response to the pet pulling. The method can include retracting the length of flexible material in response to the pet not pulling. The method can include producing one or more noises, via a clicking mechanism, in response to the length of flexible material moving in a first direction.

In some embodiments, the retracting the length of flexible material in response to the pet not pulling can be automatically performed via one or more springs biased to retract the length of flexible material. In some embodiments, the clicking mechanism can be configured to produce one or more noises every time a first length of the length of flexible material moves in the first direction. In some embodiments, the clicking mechanism can produce the one or more noises electronically. In some embodiments, the first direction can be an extending direction. In some embodiments, the first direction can be a retracting direction. In some embodiments, the method can include clipping, via a leash clip, the leash training system to a collar or harness on the pet. The method can include clipping, via a leash attachment connector, the leash training system to a leash.

In another example embodiment, a leash training system is provided. The leash training system can include a retractable leash assembly. The retractable leash assembly can include a housing. The retractable leash assembly can include a spool. The spool can include a spring. The spring can be configured to bias the spool in a spooled configuration. The retractable leash assembly can include a length of flexible material having a first end and a second end. The length of flexible material can be configured to wind around the spool and move between the spooled configuration and an unspooled configuration. The leash training system can include a clicking mechanism. The clicking mechanism can configured to produce one or more noises when the length of flexible material moves in a first direction. The leash training system can include a leash attachment connector. The leash attachment can be coupled to the housing. The leash attachment connector can be configured to removably couple the leash training system to a leash. The leash training system can include a leash clip. The leash clip can be configured to removably couple the leash training system to a pet. The leash training can include a safety strap having a first end and a second end. The leash training system can be disposed between the leash and the pet. The first end of the length of flexible material can be coupled to the leash clip. The second end of the length of flexible material can be coupled to the spool. The first end of the safety strap can be coupled to the leash clip. The second end of the safety strap can be coupled to the leash attachment connector.

In some embodiments, the clicking mechanism can be configured to produce a noise every time a first length of the length of flexible material moves in the first direction. In some embodiments, the clicking mechanism can be configured to produce a noise every time the spool rotates a first angle of rotation.

### BRIEF DESCRIPTION OF THE DRAWINGS

Reference will now be made to the accompanying drawings, which are not necessarily drawn to scale, and wherein:

FIG. 1A illustrates a side view of a leash training system in accordance with one or more example embodiments described herein;

FIG. 1B illustrates a cutaway side view of a leash training system in accordance with one or more example embodiments described herein; and

FIG. 2 illustrate a block flow diagram of a method of leash training in accordance with one or more example embodiment described herein.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

It should be understood at the outset that although illustrative implementations of one or more aspects are illustrated below, the disclosed assemblies, systems, and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents. While various elements are illustrated, the drawings may not be to scale.

The words “example,” or “exemplary,” when used herein, are intended to mean “serving as an example, instance, or illustration.” Any implementation described herein as an “example,” “embodiment,” or “exemplary embodiment” is not necessarily preferred or advantageous over other implementations.

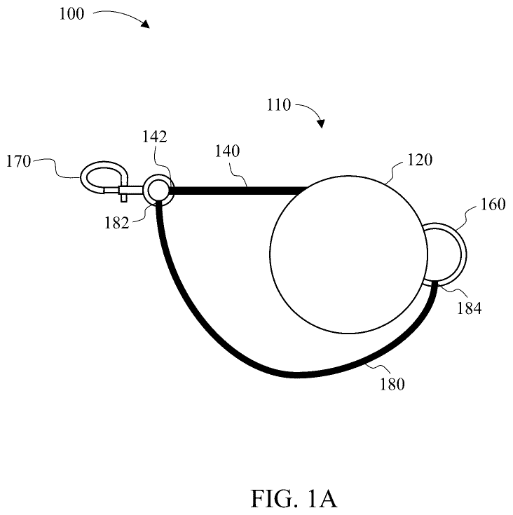

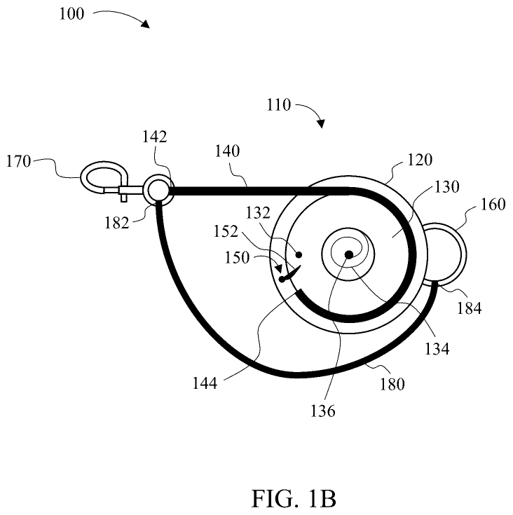

FIGS. 1A and 1B illustrates a leash training system in accordance with one or more example embodiments described herein. In particular, FIGS. 1A and 1B illustrate an example leash training system 100 comprising a retractable leash assembly 110, a clicking mechanism 150, a leash attachment connector 160, and leash clip 170 configured to attach to a leash and a collar or harness for use in leash training a pet or other animal. For example, the leash training system 100, can be configured to create a noise, such as a click, via the clicking mechanism 150, to mark a behavior, such as the animal pulling the leash. This marking can be used as a training aid in leash training the animal. In various embodiments, the leash attachment connector 160 and leash clip 170 may be configured to attach to a leash and a collar/harness respectively, such as a standard dog leash and dog collar/harness. For example, the leash training system 100 can be configured to connect to a dog leash, via the leash attachment connector 160, and connect to a dog collar/harness, via the leash clip 170, such that the leash training system 100 can be disposed between the leash and the collar/harness. In this way, instead of connecting a leash directly to a collar/harness, a pet owner can connect the leash to the leash training system 100 and the leash training system 100 can be connected to the collar/harness.

As illustrated, in various embodiments, a leash training system 100 may include a retractable leash assembly 110. The retractable leash assembly 110 can include a housing 120, a spool 130, and a length of flexible material 140. For example, the spool 130 may be disposed within the housing 120 and the length of flexible material 140 may be wound around the spool 130 and configured to spool and unspool. The spool 130 can be any device around which a flexible material can be wound and unwound such as a spool, reel, bobbin, cylinder, roll, winder, and/or the like. The length of flexible material 140 can be any flexible material, such as any material used in standard dog leashes. For example, the flexible material 140 can be any dog leash type such as leather, nylon, biothane, webbing, plastic, rope, string, and/or the like. Alternatively, or in addition, the flexible material 140 can be a length of material used in retractable dog leashes. The length of flexible material 140 can include a first end 142 and a second end 144. The second end 144 can be attached to the spool 130 and the first end 142 can be disposed outside the housing 120. For example, when in the spooled configuration, the length of flexible material 140 can be wound around the spool 130 with the first end 142 disposed outside the housing 120. As the length of flexible material 140 is moved to an unspooled configuration, such as by a force pulling on the first end 142, the length of flexible material 140 can unspool out of the housing 120. In the unspooled configuration, the length of flexible material 140 can be fully unwound from the spool 130 with the second end 144 remaining attached to the spool 130. The retractable leash assembly 110 can further retract such that the length of flexible material 140 moves from the unspooled configuration to a spooled configuration. The retraction of the length of flexible material 140 can be automatic. For example, the spool 130 can be biased to the spooled configuration such that when no outside force is pulling the flexible material 140 in the unspooling direction, the flexible material retracts in the spooled direction. Alternatively, or in addition, the automatic retraction of the length of flexible material 140 can be triggered by a release, such as by pressing a button.

In various embodiments, the clicking mechanism 150 can be configured to produce one or more sounds in response to the length of flexible material 140 moving. For example, the clicking mechanism can be configured to produce a sound when a dog pulls on the leash, thus causing the length of flexible material 140 to unspool. In this way, the sound can be used as no reward marker (NRM) to mark a negative behavior that a trainer is trying to discourage. For example, a trainer can provide negative feedback to a pet every time the clicking mechanism 150 produces a sound in response to pulling. The clicking mechanism 150 can be configured to produce a noise every time a certain length of the length of flexible material 140 is unspooled. Alternatively, or in addition, the clicking mechanism 150 can be configured to produce a noise every time the spool 130 rotates a certain angle of rotation in the unspooling direction. For example, the clicking mechanism 150 can be configured to produce a noise every time the spool rotates 360 degrees in the unspooling direction. Alternatively, or in addition, the clicking mechanism 150 can be configured to trigger every time the spool 130 rotates an angle less that one full revolution. For example, the clicking mechanism 150 can be configured to click every 180-degree revolution, 90-degree revolution, 45-degree revolution, and/or the like. Alternatively, or in addition, the clicking mechanism 150 can be configured to click every time the spool 130 rotates more than one full revolution. For example, the clicking mechanism 150 can be configured to click every other revolution, every third revolution, every fourth revolution, every fifth revolution, every tenth revolution, and/or the like.

Alternatively, or in addition, the clicking mechanism 150 can be configured to produce one or more sounds when a dog does not pull on a leash. For example, if a dog is pulling on the leash and then begins to let up or not pull, the clicking mechanism 150 can produce a sound to mark the non-pulling behavior. In this way, the sound can be used as a reward marker in pet training. For example, a trainer can provide a treat every time the clicking mechanism 150 produces a sound in response to non-pulling to provide positive reinforcement for the behavior. As explained herein, when a dog is pulling, the length of flexible material 140 can be in a partially or fully unspooled configuration. If the dog lets up and the pulling force on the length of flexible material 140 is removed, or reduced, the length of flexible material 140 can be retracted and/or spooled into the housing 120. The clicking mechanism 150 can be configured to mark this behavior (e.g., not pulling) by producing a noise such as a click. For example, the clicking mechanism 150 can be configured to produce a noise every time a certain length of the length of flexible material 140 is retracted and/or spooled. Alternatively, or in addition, the clicking mechanism 150 can be configured to produce a noise every time the spool 130 rotates a certain angle of rotation in the spooling direction. For example, the clicking mechanism 150 can be configured to produce a noise every time the spool 130 rotates 360 degrees in the spooling direction. Alternatively, or in addition, the clicking mechanism 150 can be configured to trigger every time the spool 130 rotates an angle less that one full revolution. For example, the clicking mechanism 150 can be configured to click every 180-degree revolution, 90-degree revolution, 45-degree revolution, and/or the like. Alternatively, or in addition, the clicking mechanism 150 can be configured to click every time the spool 130 rotates more than one full revolution. For example, the clicking mechanism 150 can be configured to click every other revolution, every third revolution, every fourth revolution, every fifth revolution, every tenth revolution, and/or the like.

In various embodiments, the clicking mechanism 150 can produce any sound. For example, the clicking mechanism 150 can produce a click. Alternative, or in addition, the clicking mechanism 150 can produce any other sound, such as a beep, honk, screech, ding, ring, voiced word or phrase, and/or the like. For example, if a clicker is already being used by a dog trainer as a reward marker (e.g., using a hand clicker to reward behaviors such as sitting) then a trainer may wish to use a different sound to mark when the dog is doing a negative behavior such as pulling. As such, the clicking mechanism 150 can be configured to produce one or more sounds other than a click. For example, the clicking mechanism 150 can produce a beep as a no reward marker (NRM) when a dog is pulling on the leash. The clicking mechanism 150 can produce a sound mechanically. Alternatively, or in addition, the clicking mechanism 150 can produce a sound electronically.

In various embodiments, the clicking mechanism 150 can be configured to produce one or more sounds mechanically. For example, the clicking mechanism 150 can be configured to produce one or more noises through mechanical movement or elastic deformation. The clicking mechanism 150 can be any mechanical clicking mechanism known in the art. For example, as illustrated in FIG. 1B, the clicking mechanism 150 can include one or more clicking mechanism protrusions 152 and the spool 130 can include one or more spool protrusions 132. The one or more clicking mechanism protrusions 152 can be configured to mechanically interact with the one or more spool protrusions 132 when the spool 130 unspools and/or spools (e.g., rotates). For example, a spool protrusion 132 may interact with a clicking mechanism protrusion 152 and cause the clicking mechanism protrusion 152 to move, rotate, or elastically deform until the spool protrusion 132 passes the clicking mechanism protrusion 152 causing the clicking mechanism protrusion 152 to snap back into place creating one or more noises. Alternatively, or in addition, a spool protrusion 132 may interact with a clicking mechanism protrusion 152 and cause the spool protrusion 132 to move, rotate, or elastically deform until the spool protrusion 132 passes the clicking mechanism protrusion 152 causing the spool protrusion 132 to snap back into place creating one or more noises.

Alternatively, or in addition, the clicking mechanism 150 can be clickwheel mechanism configured to click every time the spool rotates a certain amount. Clickwheels, also known as a surveyor's wheel, odometer, measuring wheel, or trundle wheel, are mechanisms known in the art. These devices can include a clicking mechanism that is triggered every time a wheel rotates a certain amount. For example, the clicking mechanism of a clickwheel can be configured to trigger (e.g., click) every time a wheel of the clickwheel rotates one full revolution. Alternatively, or in addition, the clicking mechanism of a clickwheel can be configured to trigger every time a wheel rotates an angle less that one full revolution. For example, the clicking mechanism can be configured to click every 180-degree revolution, 90-degree revolution, 45-degree revolution, and/or the like. Alternatively, or in addition, the clicking mechanism can be configured to click every time the wheel rotates more than one full revolution. For example, the clicking mechanism can be configured to click every other revolution, every third revolution, every fourth revolution, every fifth revolution, every tenth revolution, and/or the like. The clicking mechanism 150 can be any clicking mechanism such as the clicking mechanism of a clickwheel described above and can be configured to trigger every time the spool rotates a certain amount.

Alternatively, or in addition, the clicking mechanism 150 can be configured to produce one or more sounds electronically. For example, the clicking mechanism 150 can include a speaker for producing one or more sounds. The clicking mechanism 150 can further include one or more sensors for determining a direction and movement of the length of flexible material 140. For example, the one or more sensors can determine that a certain length of the length of flexible material 140 has unspooled and/or spooled and in response trigger one or more noises. Alternatively, or in addition, the one or more sensors can determine that the spool 130 has rotated a certain angle of rotations and, in response, trigger one or more noises.

In various embodiments, the clicking mechanism 150 can be configured to produce one or more noises when the length of flexible material 140 moves in a first direction and not produce one or more noises when the length of flexible material 140 moves in a direction opposite the first direction. For example, the clicking mechanism 150 can be configured to produce one or more noises when the length of flexible material 140 extends and/or unspools and not produce one or more noises when the length of flexible material 140 retracts and/or spools. Alternatively, the clicking mechanism 150 can be configured to produce one or more noises when the length of flexible material 140 retracts and/or spools and not produce one or more noises when the length of flexible material 140 extends and/or unspools. Alternatively, the clicking mechanism 150 can be configured to produce one or more noises when the length of flexible material moves in a first direction and in a second direction. For example, the clicking mechanism 150 can be configured to produce one or more noises when the length of flexible material 140 extends and/or unspools and retracts and/or spools. Alternatively, or in addition, the clicking mechanism may be selectable such that a user can select one or more direction in which the movement of the length flexible material 140 in that direction triggers the clicking mechanism 150 to produce one or more noises. For example, the clicking mechanism 150 may be selectable to produce one or more noises when the length of flexible material 140 extends and/or unspools or to produce one or more one or more noises when the length of flexible material 140 retracts and/or spools. In this way, a user can select between using the clicking mechanism 150 as a no reward marker when the pet pulls or a reward marker when the pet does not pull.

In various embodiments, the leash attachment connector 160 can be configured to removably couple with a standard dog leash by the dog leash clipping to the leash attachment connector 160. The leach attachment connector 160 can be a ring, hook, loop, eyelet, clip and/or the like for securely and removably coupling with a standard dog leash or other kind of leash.

In various embodiments, the leash clip 170 can be a configured to removably couple with a standard dog collar and/or harness by clipping the leash clip 170 to the standard dog collar and/or harness. The leash clip 170 can be any type of removable coupling mechanism such as, a clip, carabiner, buckle and/or the like.

As illustrated, in various embodiments, the leash training system 100 may include a safety strap 180. For example, the safety strap 180 can provide a backup connection between a leash and collar/harness such that the pet remains leashed in case there is a failure or breakage in the other portions of the leash training system 100, such as the spool 130 or length of flexible material 140 breaking. The safety strap 180 may include a first end 182 and a second end 184. The first end 182 may be configured to couple with the leash clip 170. For example, the first end 182 may be configured to attach to the leash clip 170. Alternatively, or in addition, first end 182 may be configured to couple with a collar and/or harness. For example, the first end 182 may be configured to removably clip to a dog collar/harness. The second end 184 may be configured to couple with the leash attachment connector 160. For example, the second end 184 may be configured to attach to the leash attachment connector 160. Alternatively, or in addition, the second end 184 may be configured to couple with a leash. For example, the second end 184 may be configured to removably clip to a dog leash. The safety strap 180 can be any flexible material, such as any material used in standard dog leashes. For example, the safety strap 180 can be any dog leash type such as leather, nylon, biothane, webbing, plastic, rope, string, and/or the like. Alternatively, or in addition, the safety strap 180 can be a length of material used in retractable dog leashes. The safety strap 180 can be long enough to allow the length of flexible material 140 to fully extend and/or unspool.

In various embodiments, the spool 130 may include one or more springs that are configured to bias the spool 130 in a spooled configuration. For example, as illustrated in FIG. 1B, the spool 130 can include a spring 134 disposed about the axis of rotation 136 of the spool 130. The spring 134 can be configured to wind up as the spool 130 rotates in the unspooling direction. Alternatively, the spring 134 can be configured to wind up as the spool 130 rotates in the spooling direction. The spring 134 can be a flat coil torsion spring. Alternatively, or in addition, the spool 130 can include one or more springs such as a torsion spring, flat coil torsion spring, extension spring, tension spring, constant force spring, compressions spring, clock spring, coil spring and/or the like, or any combination thereof.

In various embodiments, the leash training system 100, can be configured to provide tactile feedback alternatively, or in addition to, the audible feedback described herein. For example, the leash training system 100 can be configured to provide tactile feedback when the clicking mechanism 150 produces one or more noises. The tactile feedback can be an increasing resistance as the length of flexible material 140 extends and/or unspools as a pet pulls followed by a release of the resistance when the clicking mechanism 150 produces one or more noises. For example, the clicking mechanism 150 can itself cause an increased resistance and then release when the one or more noises is mechanically produced by the clicking mechanism 150. As described herein, the one or more noised can be mechanically produced through a mechanical interaction between protrusions. This mechanical interaction can create increasing resistance as the protrusions elastically deforms or moves until the resistance is released as the protrusions pass each other causing one or more of the protrusions to snap back creating one or more noises. Alternatively, or in addition, the leash training system 100 can be configured to provide tactile feedback electronically. Alternatively, or in addition, the leash training system 100 can be configured to provide tactile feedback without the accompanying audible feedback. Alternatively, or in addition, the leash training system 100 can be configured to provide tactile feedback in response to a pet not pulling. For example, the leash training system 100 can be configured to provide tactile feedback as the length of flexible material 140 retracts and/or spools.

In various embodiments, the leash training system 100 can be configured to couple with a pet collar or harness such that it can remain attached to the collar or harness at all times. For example, the leash training system 100 can be configured to clip onto to a collar or harness such that the leash training system 100 sits relatively flush with the collar or harness. The leash training system 100 can include a receiving portion configured to attach to a collar or harness and further configured to receive the housing 120 of the retractable leash assembly 110. For example, the housing 120 can be configured to snap into the receiving portion to securely and removably attach the housing 120 to a collar or harness.

In various embodiments, the leash training system 100 can be configured to communicate with an electronic pet collar used to provide feedback to a pet. For example, electronic dog collars are known in the art and used to produce audible or physical feedback to a dog. Electronic dog collars can be configured to produce one or more noises, vibrate, or provide static feedback (e.g., a shock) to a dog. The leash training system 100 can be configured to trigger an electronic collar to produce feedback to the pet. For example, the leash training system 100 can include a processor in communication with an electronic collar and configured to trigger one or more feedbacks to the pet from the electronic collar in response to the length of flexible material 140 fully extending and/or unspooling. Alternatively, or in addition, the leash training system 100 can be configured to trigger a plurality of feedback to the pet from the electronic collar in response the pet pulling. For example, the leash training system 100 can be configured to trigger one or more warning feedbacks, such as a sound or vibration, to the pet from the electronic collar in response to the length of flexible material 140 extends and/or unspooling. The leash training system 100 can be configured to then provide a different feedback, such as static feedback, to the pet from the electronic collar in response to the length of flexible material 140 fully extends and/or unspools. In this way, the leash training system 100 can provide a pet with warning feedback as it begins pulling and unspooling the length of flexible material 140 and then provide a different and potentially stronger feedback, like static feedback, if the pet continues to pull and fully extends or unspools the length of flexible material 140. Alternatively, or in addition, the leash training system 100 can be configured to trigger the electronic collar to provide a feedback to the pet every time the clicking mechanism 150 is triggered. Alternatively, or in addition, the leash training system 100 can be configured to trigger the electronic collar to provide a feedback to the pet every time a certain length of the length of flexible material 140 moves in a direction. Alternatively, or in addition, the leash training system 100 can be configured to trigger the electronic collar to provide a feedback to the pet every time the spool 130 rotates a certain angle of rotation. Alternatively, or in addition, the leash training system 100 can be configured to trigger the electronic collar to provide one or more feedbacks to a pet based on the pull force applied to the leash training system 100. For example, the leash training system 100 can include a sensor for measuring pull force, such as a force gauge, push-pull gauge, pull force gauge, and/or the like. The pull force sensor can be configured to measure the pull force exerted on the length of flexible material 140 and the leash training system 100 can be configured to trigger one or more feedbacks of the electronic collar based on the measured pull force. The leash training system 100 can be configured to have different pull force thresholds which, when met, trigger one or more electric collar feedback. For example, the leash training system 100 can be configured to have a first pull force threshold and a higher second pull force threshold and be configured to trigger a warning feedback from the electric collar, such as a sound or vibration, when the first pull force threshold is met and trigger a second feedback, such as static feedback, when the second pull force threshold is met.

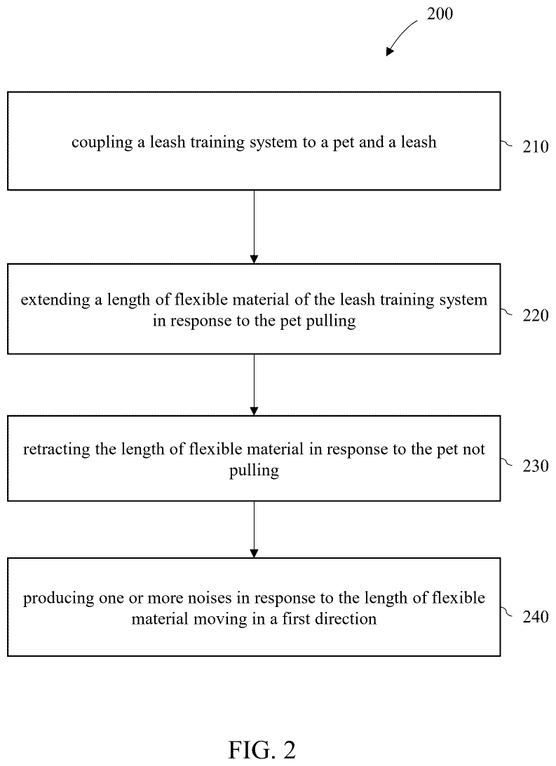

FIG. 2 illustrates a method 200 for leash training. The method 200 can include, at 210, coupling a leash training system to a pet and a leash. The leash training system can be disposed between the pet and the leash. For example, the leash training system can clip to a pet leash or harness and further a leash can clip to the leash training system. The method 200 can include, at 220, extending a length of flexible material of the leash training system in response to the pet pulling. For example, in response to a pet pulling when walking on a leash, the leash training system can extend and/or unspool a length of flexible material. The method can include, at 230, retracting the length of flexible material in response to the pet not pulling. For example, in response to a pet not pulling when walking on a leash, the leash training system can retract and/or spool the length of flexible material. The retraction can be performed automatically, via a spring or other mechanism that biases the leash training system to a retracted and/or spooled configuration. The method 200 can include, at 240, producing one or more noises in response to the length of flexible material moving in a first direction. For example, the leash training system can produce one or more noises when a pet pulls on the leash causing the length of flexible material to extend and/or unspool. Alternatively, or in addition, the leash training system can produce one or more noise when a pet does not pull on the leash causing the length of flexible material to retract and/or spool. The one or more noises can be produced via a clicking mechanism.

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A leash training system comprising:
a retractable leash assembly comprising:
a housing;
a spool; and
a length of flexible material having a first end and a second end, wherein the length of flexible material is configured to wind around the spool and move between a spooled configuration and an unspooled configuration;
a clicking mechanism configured to produce one or more noises when the length of flexible material moves in a first direction;
a leash attachment connector coupled to the housing and configured to removably couple the leash training system to a leash; and
a leash clip configured to removably couple the leash training system to a pet,
wherein the first end of the length of flexible material is coupled to the leash clip and the second end of the length of flexible material is coupled to the spool, and
wherein the clicking mechanism is selectable such that a user can select the first direction to be one of an unspooling direction in which the clicking mechanism is used as a no reward marker when the pet pulls and a spooling direction in which the clicking mechanism is used as a reward marker when the pet does not pull.

2. The system of claim 1, wherein the leash training system is disposed between the leash and the pet.

3. The system of claim 1 further comprising:
a safety strap having a first end and a second end, wherein the first end of the safety strap is coupled to the leash clip and the second end of the safety strap is coupled to the leash attachment connector.

4. The system of claim 1, wherein the spool comprises a spring configured to bias the spool in the spooled configuration.

5. The system of claim 1, wherein the clicking mechanism is configured to produce one or more noises every time a first length of the length of flexible material moves in the first direction.

6. The system of claim 1, wherein the clicking mechanism is configured to produce one or more noises every time the spool rotates a first angle of rotation.

7. The system of claim 1, wherein the clicking mechanism produces one or more noises electronically.

8. The system of claim 1, wherein the clicking mechanism is further configured to provide tactile feedback comprising an increasing resistance as the length of flexible material moves in the first direction followed by a release of the resistance when the clicking mechanism produces the one or more noises.

9. The system of claim 1, wherein the spool further comprises one or more spool protrusions, and
wherein the clicking mechanism further comprises one or more clicking mechanism protrusions configured to mechanically interact with the one or more spool protrusions when the spool rotates, wherein the one or more clicking mechanism protrusions are configured to elastically deform in response to interaction with the one or more spool protrusions and snap back to produce the one or more noises.

10. The system of claim 1, wherein the leash clip is configured to removably couple the leash training system to a pet by clipping to a collar or harness on the pet.

11. A leash training method for a pet comprising:
coupling a leash training system to the pet and a leash, wherein the leash training system is disposed between the pet and the leash;
extending a length of flexible material of the leash training system in response to the pet pulling;
retracting the length of flexible material in response to the pet not pulling;
producing one or more noises, via a clicking mechanism, in response to the length of flexible material moving in a first direction,
selecting, by a user, the first direction to be one of an unspooling direction in which the clicking mechanism is used as a no reward marker when the pet pulls or a spooling direction in which the clicking mechanism is used as a reward marker when the pet does not pull.

12. The method of claim 11, wherein the retracting the length of flexible material in response to the pet not pulling is automatically performed via one or more springs biased to retract the length of flexible material.

13. The method of claim 11, wherein the clicking mechanism is configured to produce one or more noises every time a first length of the length of flexible material moves in the first direction.

14. The method of claim 11, wherein the clicking mechanism produces the one or more noises electronically.

15. The method of claim 11, wherein the clicking mechanism is further configured to provide tactile feedback comprising an increasing resistance as the length of flexible material moves in the first direction followed by a release of the resistance when the clicking mechanism produces the one or more noises.

16. The method of claim 11, wherein the clicking mechanism further comprises one or more clicking mechanism protrusions configured to mechanically interact with one or more spool protrusions of a spool of the leash training system, wherein the one or more clicking mechanism protrusions elastically deform in response to interaction with the one or more spool protrusions and snap back to produce the one or more noises.

17. The method of claim 11 further comprising:
clipping, via a leash clip, the leash training system to a collar or harness on the pet; and
clipping, via a leash attachment connector, the leash training system to a leash.

18. A leash training system comprising:
a retractable leash assembly comprising:
a housing;
a spool comprising a spring configured to bias the spool in a spooled configuration; and
a length of flexible material having a first end and a second end, wherein the length of flexible material is configured to wind around the spool and move between the spooled configuration and an unspooled configuration;
a clicking mechanism configured to produce one or more noises when the length of flexible material moves in a first direction;
a leash attachment connector coupled to the housing and configured to removably couple the leash training system to a leash;
a leash clip configured to removably couple the leash training system to a pet; and
a safety strap having a first end and a second end,
wherein the leash training system is disposed between the leash and the pet,
wherein the first end of the length of flexible material is coupled to the leash clip and the second end of the length of flexible material is coupled to the spool,
wherein the first end of the safety strap is coupled to the leash clip and the second end of the safety strap is coupled to the leash attachment connector, and
wherein the clicking mechanism is selectable such that a user can select the first direction to be one of an unspooling direction in which the clicking mechanism is used as a no reward marker when the pet pulls and a spooling direction in which the clicking mechanism is used as a reward marker when the pet does not pull.

19. The system of claim 18, wherein the clicking mechanism is configured to produce a noise every time a first length of the length of flexible material moves in the first direction.

20. The system of claim 18, wherein the clicking mechanism is configured to produce a noise every time the spool rotates a first angle of rotation.
